(19) United States
(12) Patent Application Publication
(10) Pub. No.: US 2006/0085903 A1
(43) Pub. Date: Apr. 27, 2006

(54) Bath and apparatus therefor

(76) Inventor: Egidio Renna, Milano (IT)

Correspondence Address: YOUNG & THOMPSON, 745 SOUTH 23RD STREET, 2ND FLOOR, ARLINGTON, VA, 22202, US

(21) Appl. No.: 10/509,993

(22) PCT Filed: Apr. 6, 2003
(86) PCT No.: PCT/EP03/03560

§ 371 Date: Jul. 25, 2005

(30) Foreign Application Priority Data
Apr. 5, 2002 (IT) MI2002A000719
Oct. 3, 2002 (IT) MI2002A002093
Oct. 3, 2002 (IT) MI2002A002094

(51) Int. Cl. A61H 33/02

(52) U.S. Cl. 4/546

(57) ABSTRACT

An improved bath (7) includes a pedaling apparatus (8) formed by a pedaling assembly (1) and a supporting element (6), wherein the pedaling apparatus (8) may be either integral with the bath body (7) or form a distinct pedaling apparatus (8) which can be, in turn, either removably associated with seats (9) formed in the bath body (7) or may form a distinct pedaling apparatus (8) which may be removably associated with the bath body (7) by sucker elements (13).

### BACKGROUND OF THE INVENTION

The present invention relates to an improved bath according to the preamble of claim 1 and an apparatus therefore according to claim 17.

As is known, gymnastics and physical activity in water cause considerable healthy advantages and benefits as well as reduce the risk of metabolic cardiovascular and tumoral pathologies correlated to sedentarity.

It is also known that physical exercises in water, that is in an ideal micro-gravitational environment is very advantageous for the rehabilitation of patients having articular and rheumatic pathologies for obese people, and so on.

Many proposals have been made for carrying out gymnastics and/or physical activities in water. In general they are, however, rather cumbersome, complex and expensive.

EP 1,020,205 A1 disclosed an underwater bicycle. U.S. Pat. No. 5,665,039 discloses an underwater “cyclette” for swimming-pools. WO 98/34831 discloses a swimming-pool and sea bicycle which is fastened on an own base to be placed on an swimming-pool bottom or on the beach. U.S. Pat. No. 3,791,332 discloses a bicycle-like vehicle to be use on the ground as well as in water. U.S. Pat. No. 5,586,961 discloses a rather cumbersome structure for carrying out several exercises in water. EP 0,941,747 discloses an integrated apparatus for carrying out several exercises. U.S. Pat. No. 5,752,899 discloses a system for carrying out a number of exercises with a central control of the water level and temperature as well as a system of separable “chambers” and a cycling system having a wheel and turbine assembly. U.S. Pat. No. 5,514,957 discloses an apparatus formed by a shaped mat for carrying out exercises in water involving lower limbs, stomach and backside.

### SUMMARY OF THE INVENTION

In the light of the above discussion, the main object of the present invention is to provide an improved bath allowing to carrying out pedaling exercises therein as well as an apparatus therefor.

Another object of the present invention is to provide a pedaling apparatus or assembly which may be easily associated to and removed from an existing bath.

According to the present invention, the above mentioned objects are achieved by an improved bath and a pedaling assembly therefor having the features of claims 1 and 17, respectively.

The improved bath and the pedaling assembly therefor according to the present invention provide several advantages.

First of all the suggested pedaling assemblies are simple and not cumbersome, so that they can either (in a first example) be housed directly in an improved bath or (in a second example) be removably associated to and removed from a support means integral with the bath or (in a third example) be removably associated to and removed from a common bath.

With the proposed pedaling assemblies it is, therefore, possible to carry out pedaling exercises at home, at any time and as frequent as wished, and enjoy the healty benefits of physical activities immersed in water.

The pedaling assembly according to the present invention are further cheap, light and easily transportable so that they may also be used when traveling, in hotels and so on.

The pedaling assemblies of the third example may be used in all bath types and they may be associated to the bath bottom at any distance from the user's legs, so that they may be efficiently and correctly used from tall and short people, children an so on.

### BRIEF DESCRIPTION OF THE DRAWING

Further characteristics, advantages and details of the improved bath and apparatus therefor according to the present invention will become more apparent from the following disclosure of several embodiments of the three provided types of pedaling assemblies which are schematically illustrated in the accompanying drawings, in which:

FIG. 1 is an exploded view of a pedaling assembly according to the present invention,

FIG. 2 shows a pedaling apparatus of the first type,

FIG. 3 shows a pedaling apparatus of the second type,

FIG. 4 shows a pedaling apparatus of the third type,

FIG. 5 to 7 show two embodiments of pedaling assemblies,

FIG. 8 shows a pedal,

FIGS. 9 to 12 show embodiments of the pedaling apparatuses of the first type,

FIGS. 13 to 41 show embodiments of the pedaling apparatuses of the second type,

FIG. 42 shows the pedaling position of a user in a bath, and

FIGS. 43 to 83 show embodiments of the pedaling apparatuses of the third type.

### DESCRIPTION OF THE PREFERRED EMBODIMENT

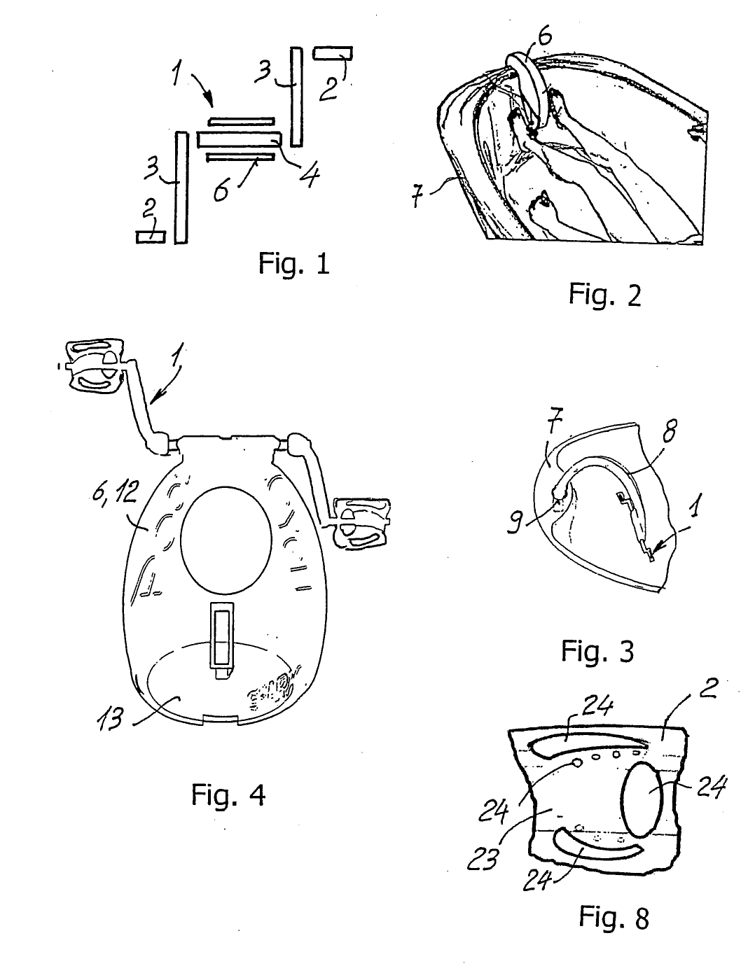

With reference to FIG. 1 a pedaling assembly 1 according to the invention comprises in principle two pedals 2, two cranks 3 and a connecting axle or shaft 4.

In all the provided embodiments said pedaling assembly I is supported by means of a supporting means 6 which may be carried out in principle in three different types which will be explained in greater detail below.

In the first type said supporting means 6 is carried out as an integral part of a bath 7, FIG. 2.

In the second type said supporting means 6 is provided in a pedaling apparatus 8 which is removably connectable to one or more bath seat/seats 9 either directly (FIG. 3) or by means of an intermediate support element as illustrated below.

In the third type said supporting means 6 is provided in a pedaling apparatus 12 having sucker means 13 allowing to said pedaling apparatus 12 to be removably connectable with the internal bath surface 14, that is the bath bottom 16 or the bath sidewalls 17, FIGS. 4, 12.

It is apparent for those skilled in the art that the simple components 2, 3 and 4 forming a pedaling assembly 1 may be either connected together in any suitable way, as known for example from the bicycle industry, or may be provided in one-piece construction, wherein in the last case the pedaling assembly 1 will looks like a crankshaft.

In the context of the present invention with the term “bath” is intended each type of bath, for example baths of any shape, baths and shower boxes having a tightly closable access door, baths having an enameled metal body, a plastic body, for example a metacrylate body, baths having an associated shower panel, and so on.

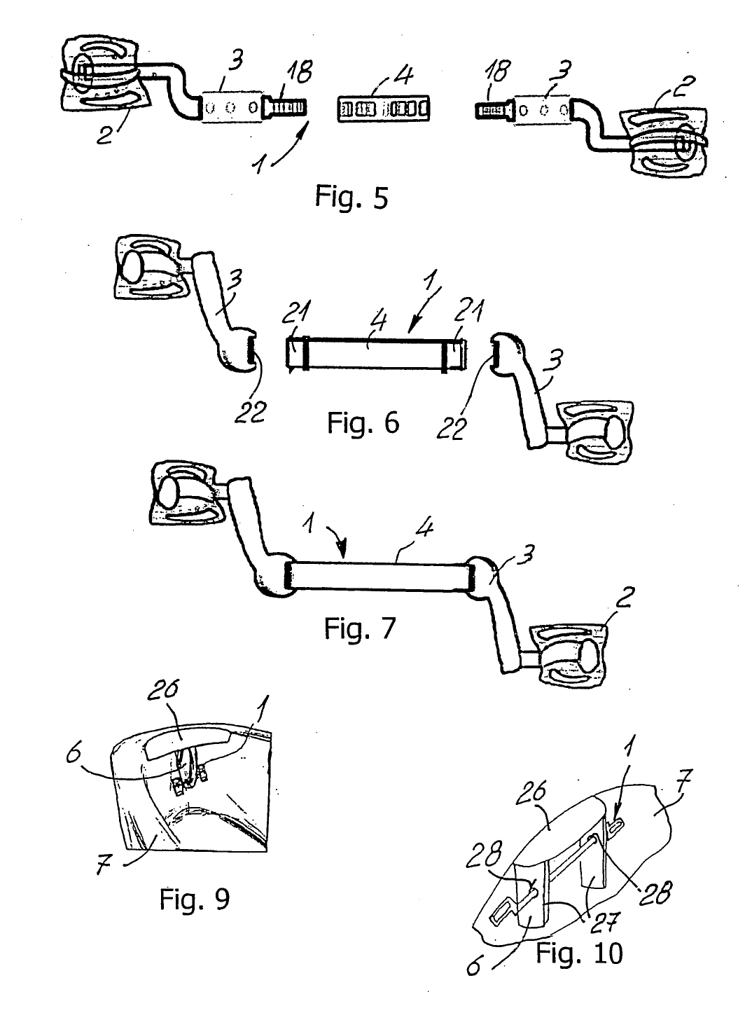

FIG. 5 shows an example of an assemblable pedal assembly 1 the cranks of which have a threaded end 18 which may be screwed into an axle 4 having corresponding threaded hole 19 at both ends thereof.

The axle ends 21 and the crank ends 22 of the pedaling assembly 1 shown in FIG. 6 are provided with a geometrical engagement and may removably assembled, e.g. clipsed, together.

The pedals 2 may have any design and consist, for example, of a plastic block or plate 23 provided with throughgoing openings 24 allowing a continuous massaging of the foot sole by the water during pedaling, FIG. 8.

As inferable from FIG. 2, said supporting means 6 may be formed by a projection 6 which is integral with the bath 7 and may have a shape at will. In the shown example said projection is box-shaped and at the lower end thereof it is provided with a—non shown—throughgoing hole in which is supported a pedal assembly 1, for example as illustrated in FIGS. 5 to 7.

In the embodiment of FIG. 9 above said projection 6 is provided a bracket 26, for example for supporting objects like soap-holder, shampoo and so om.

A similar bracket 26 is provided in the embodiment of FIG. 10, in which said supporting projection 6 is formed by two uprights 27 having throughgoing holes 28 for supporting a pedaling assembly 1.

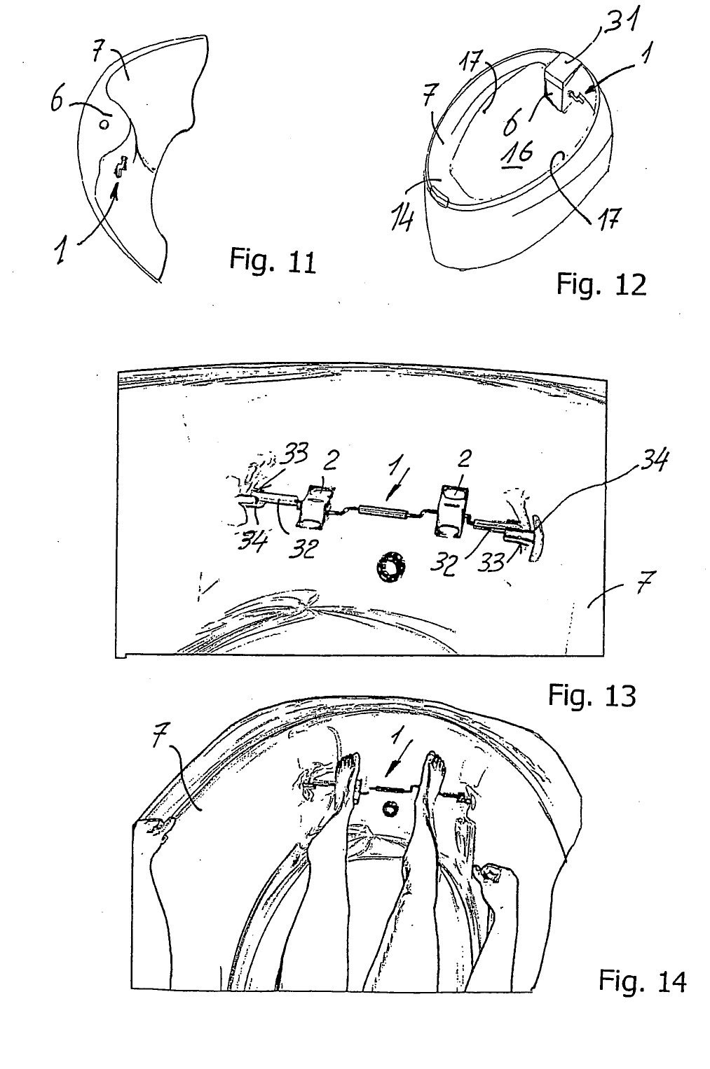

In the bath 7 shown in FIG. 11 said supporting means 6 is formed by a half-circular rib 29 in the throughgoing hole 28 is supported a pedaling assembly 1.

In the embodiment of FIG. 12 said projection 6 is cube-shaped and supports a pedaling assembly 1 as described above. On the top of said cube-shaped hollow projection 6 is provided a cover 31.

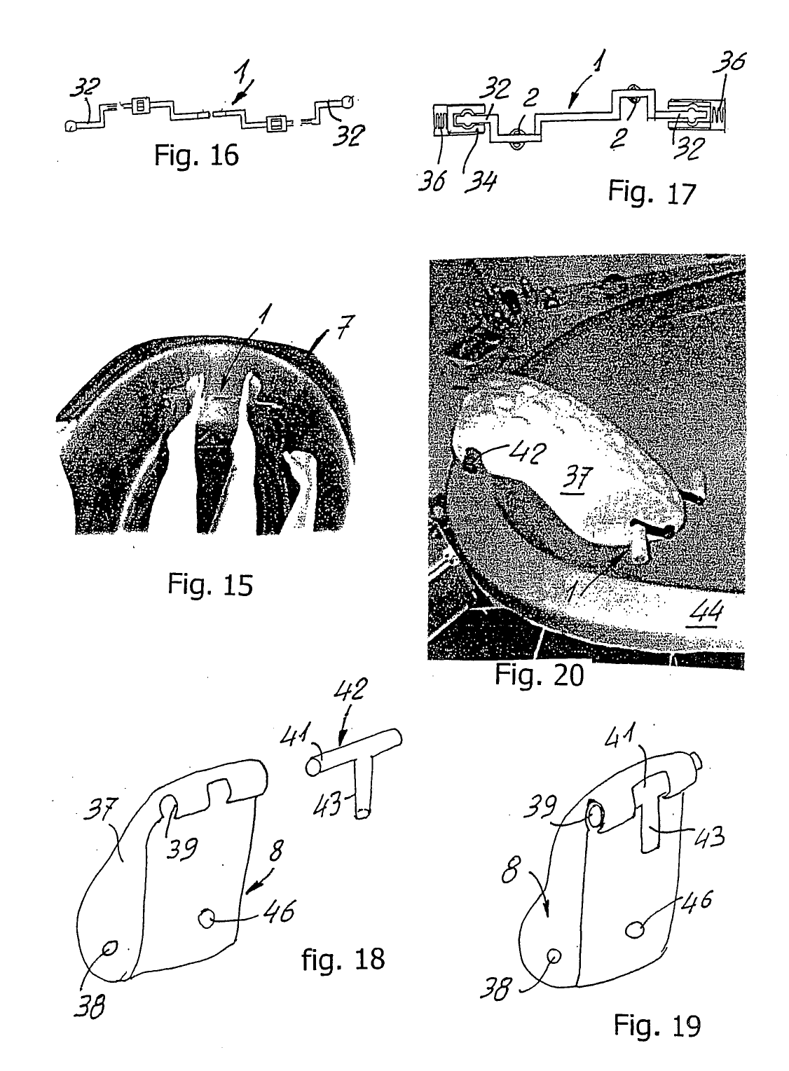

Reference is now made to the FIG. 13 to 42 showing pedaling assemblies or apparatuses 1 of the second type.

In the embodiment of FIGS. 13 to 17 the pedaling assembly 1 presents supporting ends 32 which may be removably supported in bath seats 33 which are provided in the bath sidewalls 17, preferably by interposing of an elastic sleeve 34. In said sleeves 34 may also be provided an end spring 36, as shown in FIG. 17. As already above stated, also these pedaling assemblies having supporting ends 32 may be produced as one-piece (FIG. 17) or in several pieces to be clipsed or fixed together (FIG. 16).

FIGS. 18-20 show a pedaling apparatus 8 comprising a plastic apparatus body 37 provided at the lower end with a supporting troughgoing hole 38 and at the top a seat 39 for housing the transverse leg 41 of an an intermediate T-shaped supporting element 42 the vertical leg 43 of which may be housed in a not shown corresponding seat or hole in the upper lip 44 of the bath 7. The use of this pedaling apparatus is shown in FIG. 42.

By 46 is indicated a spacer, which is preferable adjustable, for setting the whished distance between said pedaling apparatus 8 and the bath 7.

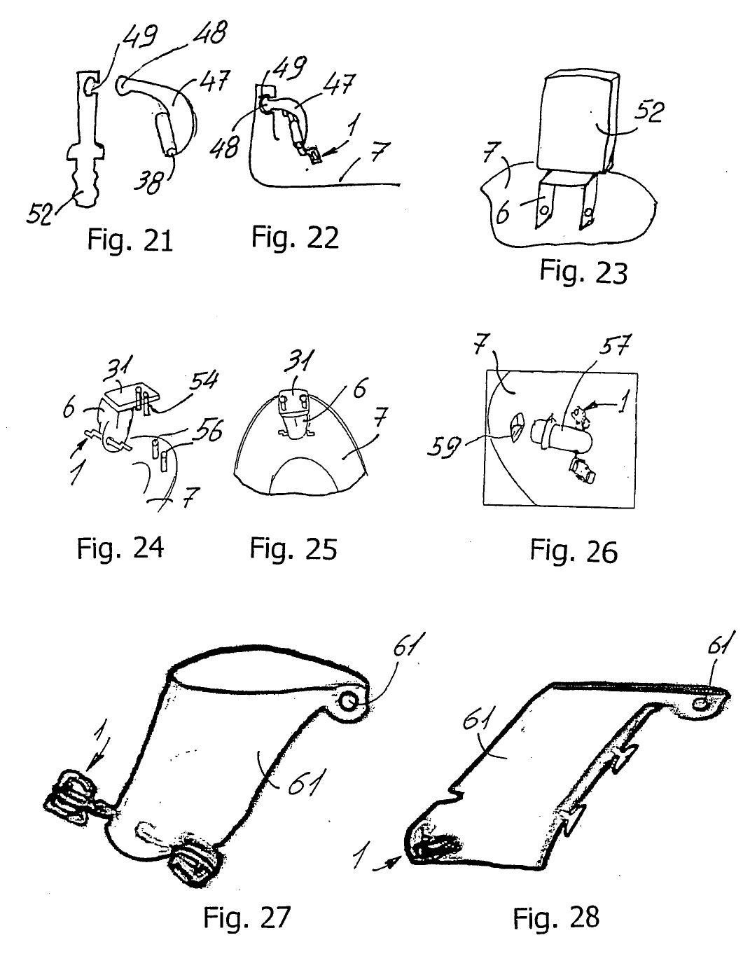

The body apparatus 47 of the embodiment of FIG. 21 is provided at the lower end with a supporting throughgoing hole 38 for supporting a pedaling assembly 1 and, at the top, with a profiled head 48. The latter may be removably inserted in a corresponding seat 49 provided in an intermediate stock-like supporting element 51 the lower end 52 of which may be inserted in e corresponding, not shown, seat in the bath upper lip.

The embodiment shown in FIG. 22 has a similar apparatus body 47 whose profiled head 48 may be inserted in a corresponding seat 51 provided in the bath 7.

FIG. 23 shows a back or shower panel 52 with associated U-shaped supporting means 6 for supporting a not shown pedaling assembly.

In the embodiment of FIG. 24 and 25 the supporting means 6 is box-shaped and provided with, in the example, two coupling collars 54 which are fastened to the cover 31 and may be inserted in two supporting pins 56 fixed to the bath lip 44.

The apparatus body 57 shown in FIG. 26 has a cylindrical shape. In the horizontal assembling position said apparatus body supports at the front end a pedaling assembly 1 and is provided with a profiled rear end 58 which may be removably coupled with a corresponding seat 59 in a bath.

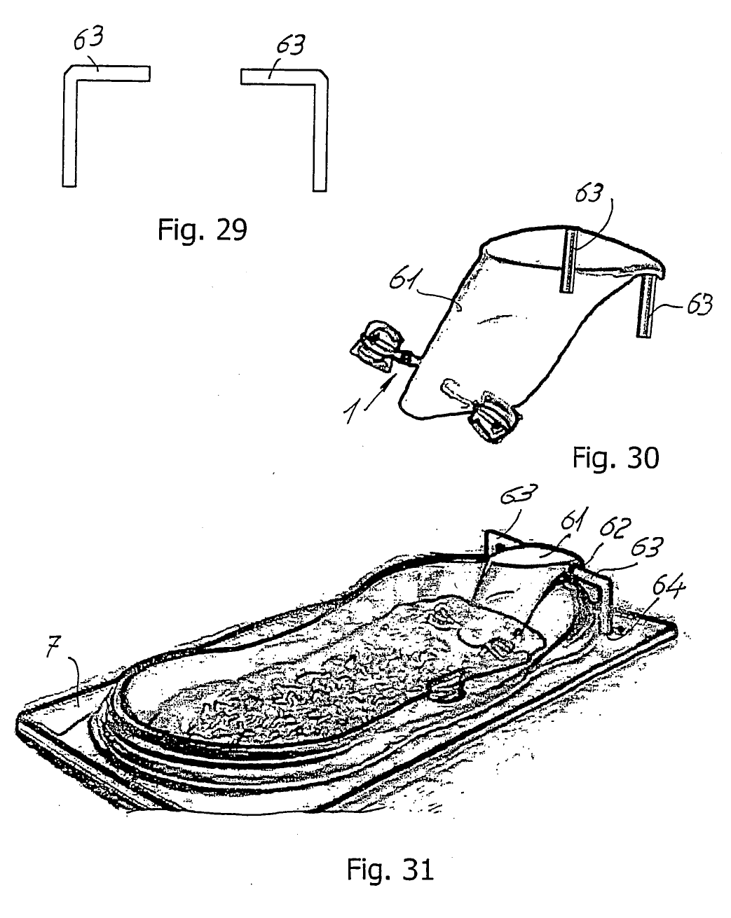

The embodiment shown in the FIGS. 27 to 31 has a plastic apparatus body 61 provided at the top with a throughgoing hole 62 for housing two L-shaped intermediate supporting elements 63 (FIG. 29). The latter, in turn, can by supported in corresponding bath seat 64. On its back side the apparatus body 61 may be provided with rubber sucker or the like 66 for a more stable positioning of said pedaling apparatus 8 against the bath 7.

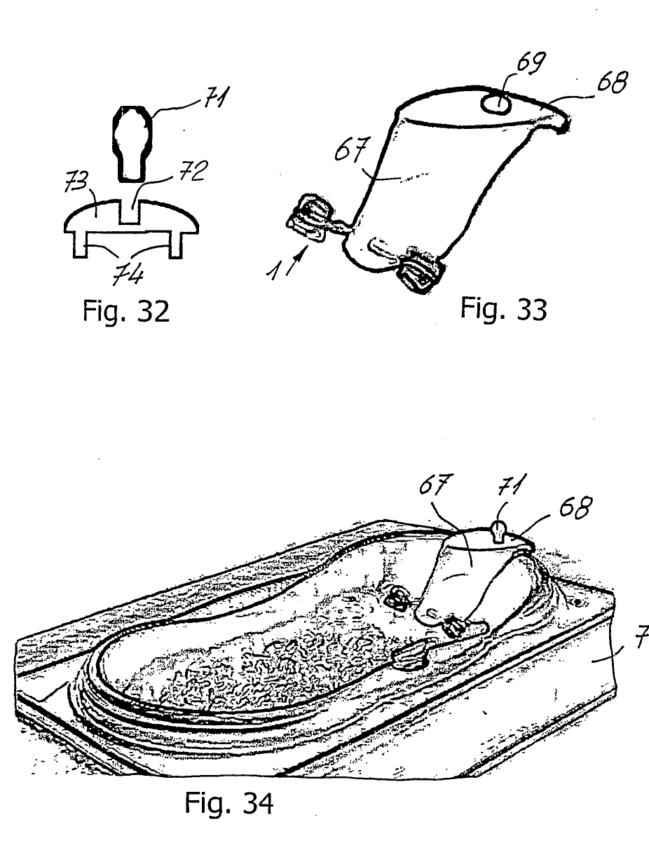

The apparatus body 67 shown in the FIGS. 32 to 34 differs from the apparatus body of the previous embodiment (FIGS. 27 to 31) by the fact that at its top in the middle of the profiled edge 68 is provided a hole 69 through which a supporting pin 71 may be inserted in the seat 72 of an intermediate supporting element 73 which, in turn, with its two pin-like projections 74 may be inserted in corresponding, not shown, bath seats.

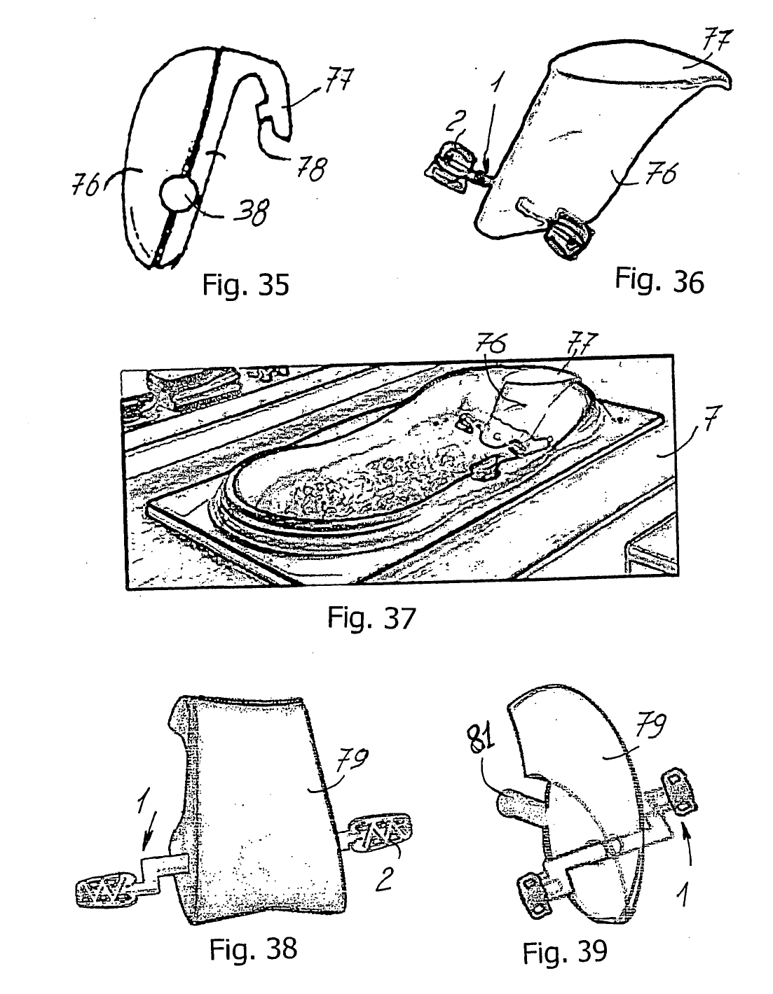

The apparatus body 76 illustrated in the FIGS. 35 to 37 is similar to those shown in the FIGS. 27 to 34 and is provided with a top rear profiled edge 77 which is bent downwards and has an internal profiled coupling element 78 which may removably be engaged in a corresponding, not shown, bath seat

FIGS. 38 and 39 show a further plastic apparatus body 79 which on the surface facing the bath 7 is provided with one or more pin-shaped coupling projection 81 which can be inserted in corresponding, not shown, bath seat/seats.

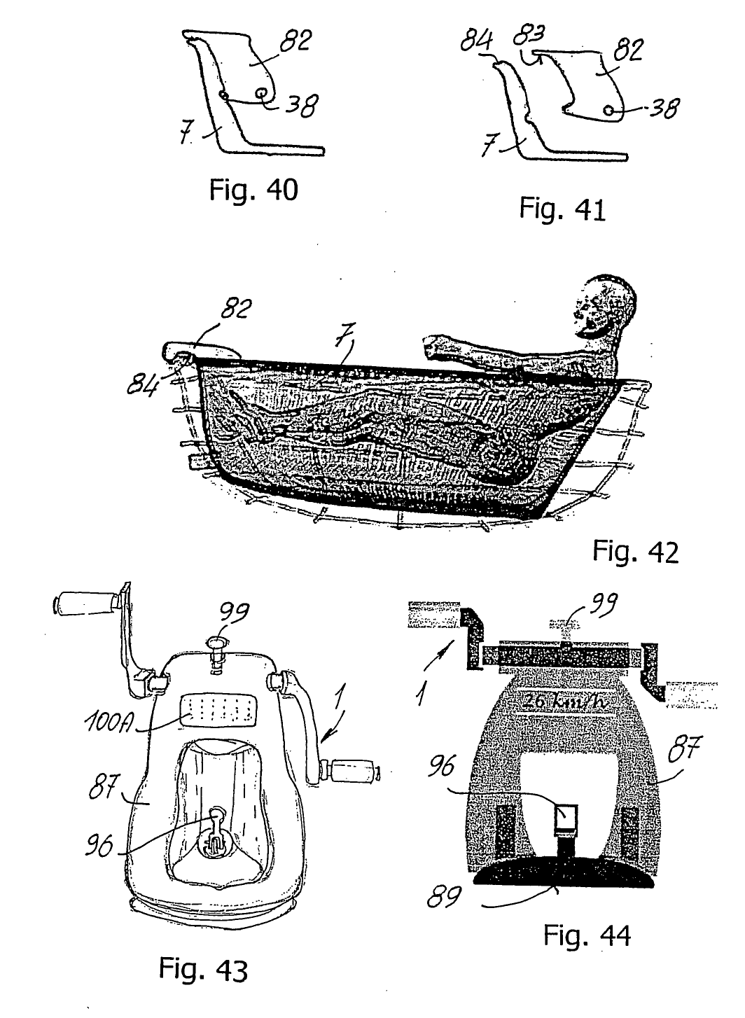

FIGS. 40 and 41 show another apparatus body 82 having at the top a profiled edge 83 corresponding to the profiled bath top edge 84 and a coupling projection 86 which, when positioning the pedaling apparatus into the bath, will be inserted in a corresponding, not shown, bath seat.

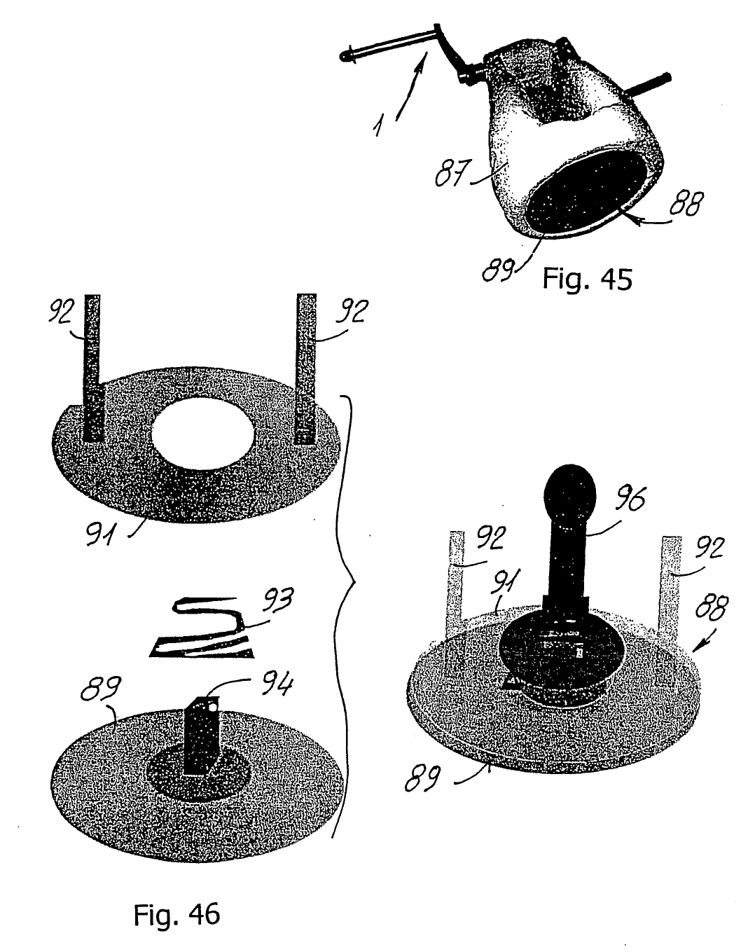

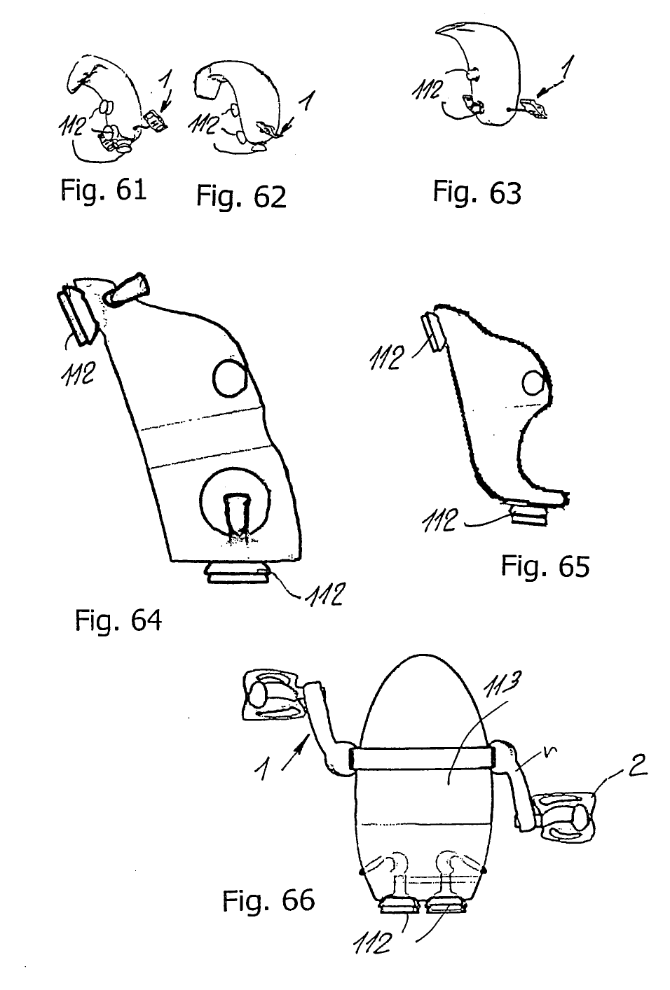

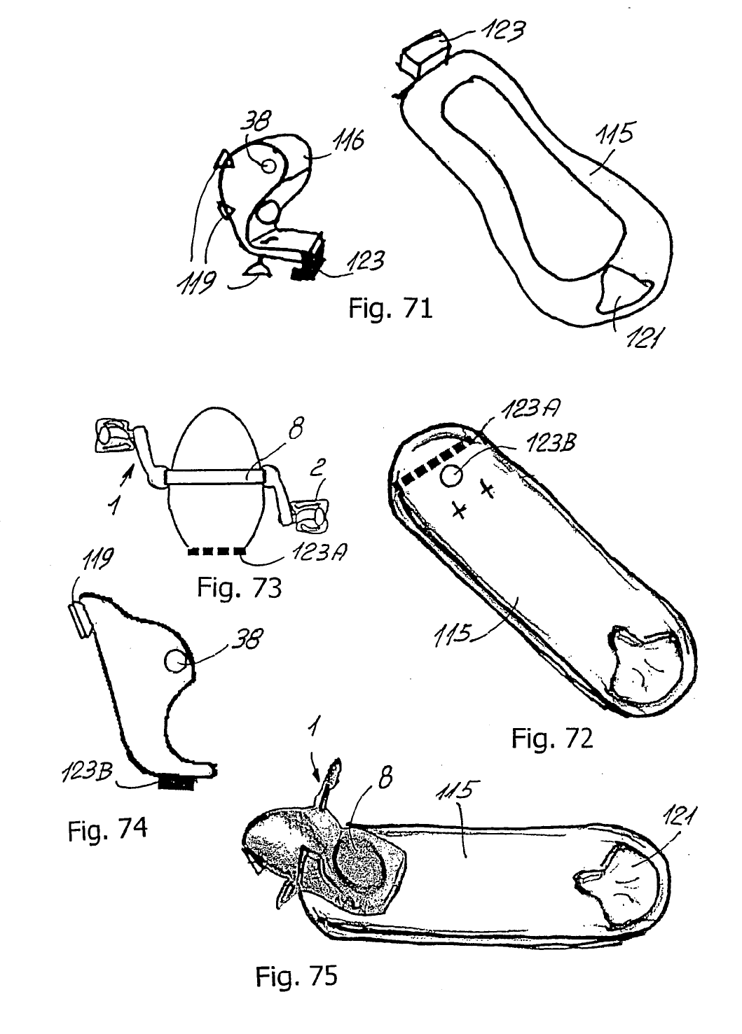

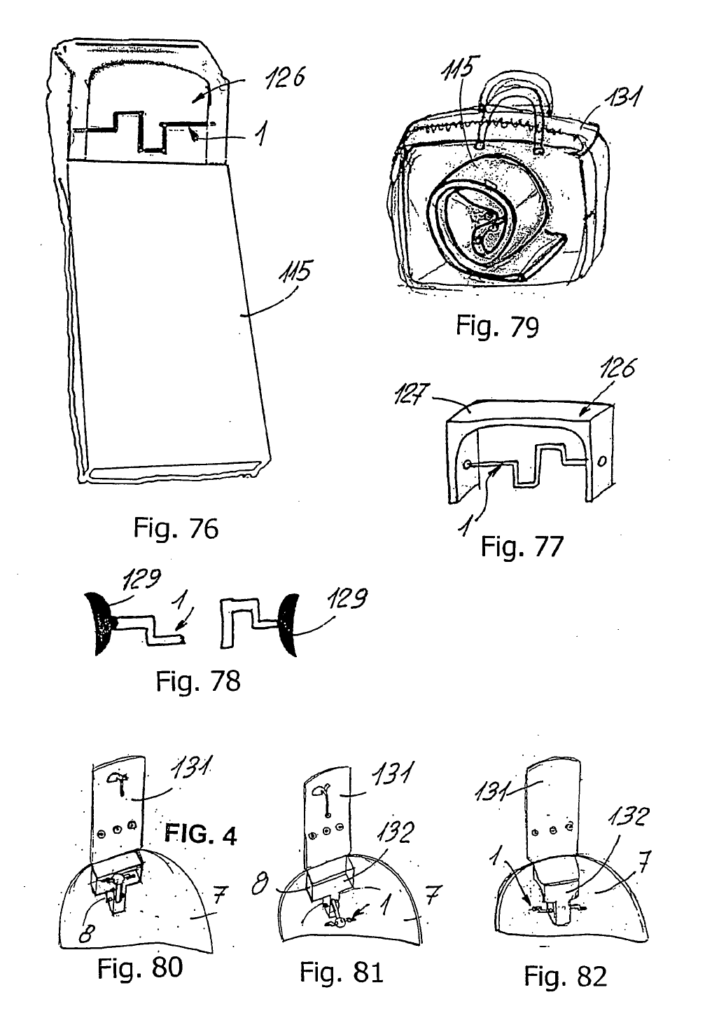

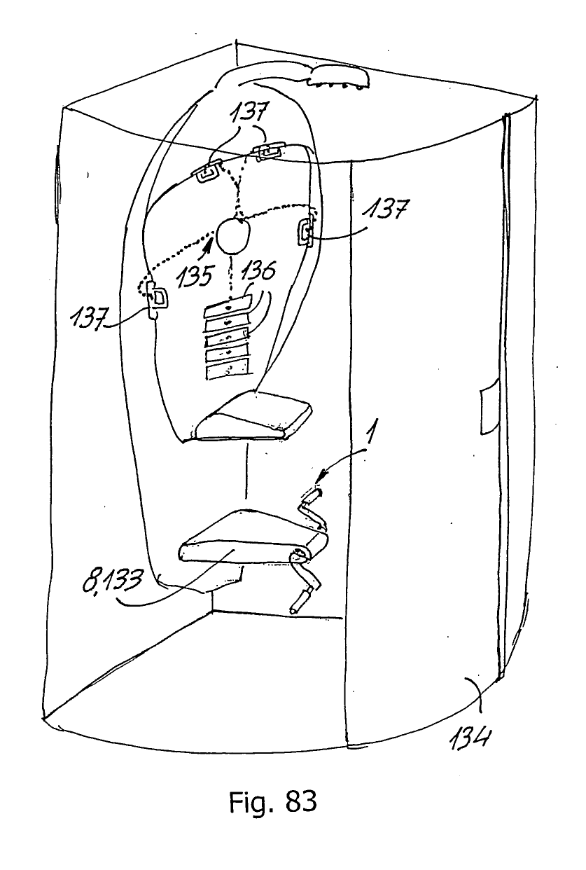

Reference is now made to the FIGS. 43 to 83 showing pedaling apparatuses of the third type.

A first embodiment of a pedaling apparatus is illustrated in FIGS. 43 to 49 and has a hollow body 87 which at the bottom houses a sucker assembly 88 comprising a rubber disk 89 and a rigid, for example metal counterdisk 91 having two positioning rod 92 and an interposed spring 93. To the rubber disk 89 is fixed a supporting base 94 on which is eccentrically hinged a control lever 96, as in principle known in industrial suckers or tightly operating suckers. The pedaling assembly 1 is housed in a bearing liner 97 incorporated at the top of said hollow body 87.

In a preferred embodiment the at the top of the hollow body 87 is also incorporated a braking shoe 98 acting on the axle 4 and controlled by a control screw 100 in order to adjust the pedaling resistance as whished by the user. By 100A is denoted a display connected with a programmed chip for indicating the pedaling speed, the set pedaling resistance, a covered pedaling distance and so on.

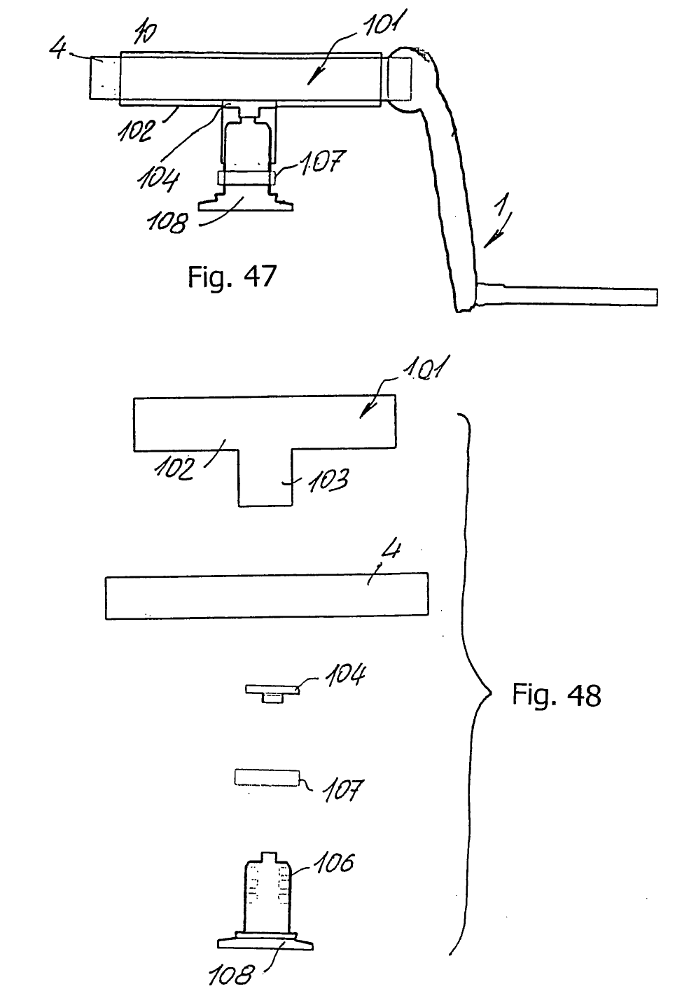

A simpler embodiment of the type illustrated in the FIGS. 43 to 46 is shown in the FIGS. 47 and 48.

A T-shaped tubular apparatus body 101 houses in its horizontal leg 102 a pedaling assembly 1 and in its vertical leg 103 a braking shoe 104 and a base 106. 107 indicates an adjusting ring for adjusting the pedaling resistance as chosen by the user.

A sucker 108 allows a stable positioning of the pedaling apparatus on the bath bottom.

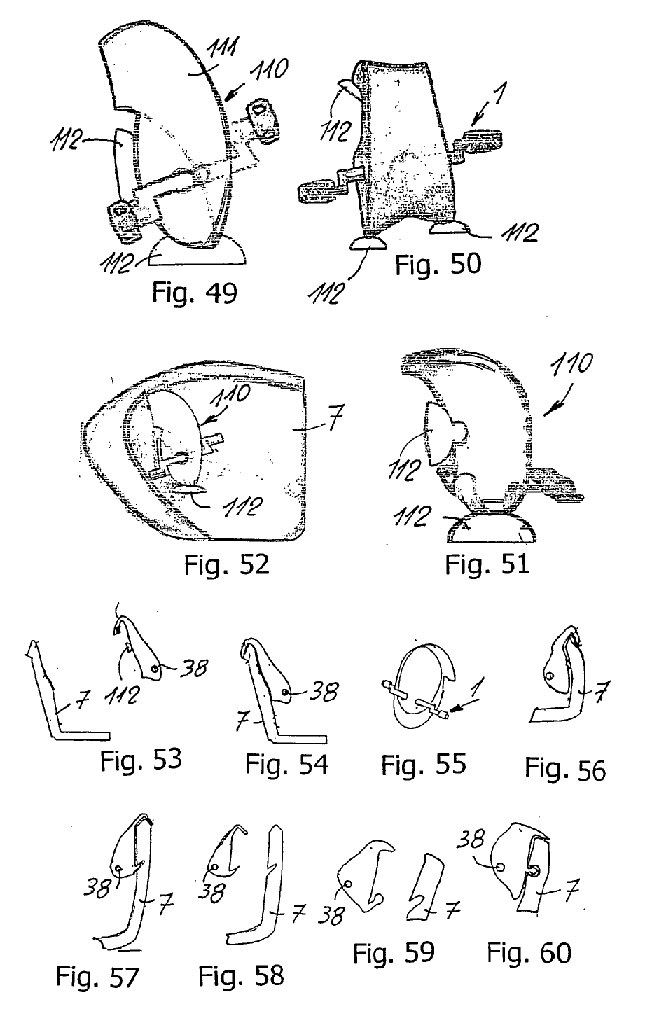

The embodiment shown in the FIGS. 49 to 51 has a plastic apparatus body 111 provided with rubber suckers 112 or the like for fixing the pedaling apparatus 110 to a bath, FIG. 52.

The embodiments shown in the FIGS. 53 to 63 illustrates different shaped pedaling apparatus bodies according to corresponding bath outlines and seats. Some apparatus bodies are also provides with rubber suckers 112.

The pedaling apparatus illustrated in FIG. 66 has an egg-shaped apparatus body 113 provided at the bottom thereof two lever control suckers 114.

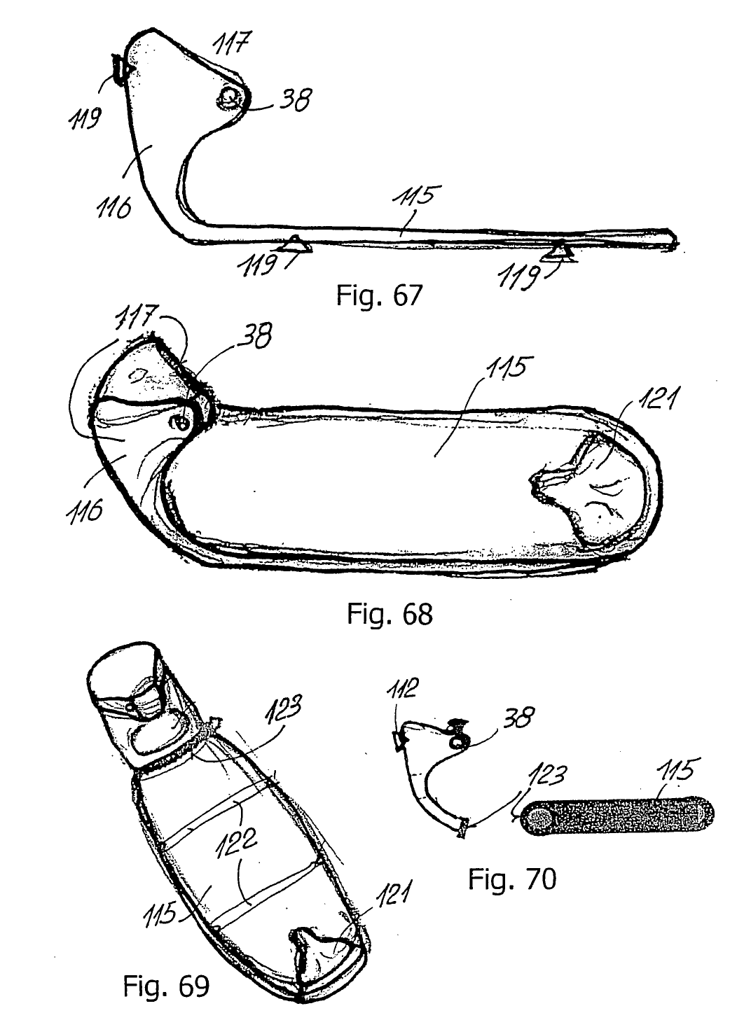

With reference to the FIG. 67 to 71 the apparatus body has the form of a thin plastic mattress or mat 115 having an upwards bent profiled end 116 with opposite flanges 117 provided with a throughgoing hole 118 for supporting a pedaling assembly 1. Suckers assuring a stable positioning of said mat 115 in the bath 7 containing water are denoted by 119.

In the embodiment illustrated in FIG. 68 on the mat end opposed to the profiled end 116 is formed a saddle 121 on which the user may sit.

In the embodiment of FIG. 69 transverse folding lines are indicated by 122. In this embodiment by 123 is further a known removable connecting means denoted, for example a zip fastener 124 allowing to separate the mat 115 from the profiled end 116 thereof.

In the embodiments of FIGS. 70, 71 and 72 other examples of separable mat and profiled ends 116 or pedaling assemblies are shown. With the mat 115 of FIG. 72 may be associated either the pedaling apparatus of FIG. 73 by using the connecting means 123A or the pedaling assembly of FIG. 74 by means of the connecting means 123B.

From FIG. 76 is inferable that a mat 115 may also be associated to a distinct pedaling apparatus 126 as shown in FIG. 77 which illustrate a pedaling assembly 1 supported in a U-shaped supporting structure 127.

Instead of the pedaling apparatus 126 said mat 115 may also be used with other pedaling apparatuses, for example with the pedaling apparatus 128. The latter comprises a pedaling assembly 1, for example in the disassemblable form, supported by two suckers 129 to be fixed to the bath sidewalls.

In FIG. 79 is shown that the met-like embodiments of the illustrated pedaling apparatuses may be transportable in a bag-like container 131.

As shown in FIGS. 80 to 83 baths are known which are provided with a shower panel 131. According to the present invention a pedaling apparatus 8 may also be provided in similar baths. As depicted in said FIGS. 80 to 83 a pedaling assembly 1 is pivotally supported in a box-like structure 132 which may be integral with the bath body or fixed to the latter by means of, not shown, suckers or the like. Said box like structure 132 may also be used as a seat. When not used the pedaling assembly 1 may be rotated inside said box-like structure 132.

A pedaling apparatus 8 may also be provided, for example as a swingable seat 133, in a shower cubicle or bathing-box 134. In the latter may also be provided a gym apparatus 135 with weights 136 which may be lifted by means of a couple of handles 137.

In practicing the invention, the above disclosed and illustrated pedaling assemblies and apparatuses will be have a size allowing a free pedaling in the baths, may be made of plastics or metal, can be subjected to several modifications and variations and it would also be possible to replace individual components with other technically equivalent components, without departing from the scope of the invention.

1. Improved bath and apparatus therefor comprising an enameled metal or plastic bath body, characterized in that the bath (7) is provided with a pedaling assembly (1) supported by a supporting means (6) which latter forms with said pedaling assembly (1) a pedaling apparatus (8), wherein said pedaling apparatus (8) may be
either integral with the bath body (7),
or form a distinct pedaling apparatus (8) which can be removably associated with seats (9) formed in the bath body (7),
or may form a distinct pedaling apparatus (8) which may be removably associated with the bath body (7) by means of sucker means (13).

2. Improved bath according to claim 1, characterized in that said supporting means integral with the bath body has a box-like or rib-like configuration.

3. Improved bath according to claim 1, characterized in that said
supporting means is formed by two uprights.

4. Improved bath according to claim 2 characterized in that said supporting means are provided with cover or an upper bracket.

5. Improved bath according to claim 1, characterized in that said pedaling assembly is a one-piece construction or the components thereof can be removably connected together.

6. Improved bath according to claim 1, characterized in that said
pedaling assembly is provided with pedal projecting ends which are covered by a plastic or rubber sleeve and may be inserted in corresponding seats formed in the bath body.

7. Improved bath according to claim 1, characterized in that said
pedaling apparatus has a profiled body which may be removably fixed with the bath by means of an intermediate supporting element and/or sucker means.

8. Improved bath according to claim 1, characterized in that said
pedaling apparatus has a hollow body housing at the bottom a sucker assembly and at the top a pedaling assembly.

9. Improved bath according to claim 8, characterized in that said
sucker assembly is a tightly operating sucker provided with a control lever.

10. Improved bath according to claim 8, characterized in that the pedaling assembly is provided with an adjustable braking shoe for adjusting the pedaling resistance.

11. Improved bath according to claim 3, characterized in that said pedaling apparatus is provided with a programmed chip and a display for showing the pedaling speed, the covered distance, and so on.

12. Improved bath according to claim 1, characterized in that said pedaling apparatus has a mat-like body provided at one end with two opposite flanges for supporting the pedaling assembly.

13. Improved bath according to claim 12, characterized in that on the free end of said mat-like body is provided a sadle-like configuration.

14. Improved bath according to claim 12, characterized in that the pedaling assembly supporting end is separable from the mat-like body.

15. Improved bath according to claim 1, characterized in that said pedaling assembly is pivotally housed in a box-like supporting means.

16. Improved bath according to claim 1, characterized in that the pedaling apparatus is carried out in the form of a swingable seat.

17. Pedaling apparatus for baths having the features stated in claim 1 and provided as a distinct pedaling apparatus.

18. Improved bath according to claim 3, characterized in that said supporting means are provided with cover or an upper bracket.
